(19) United States
(12) Patent Application Publication
(10) Pub. No.: US 2026/0283068 A1
(43) Pub. Date: Sep. 24, 2026

(54) WORKING MACHINE

(71) Applicant: HONDA MOTOR CO., LTD., Tokyo (JP)

(72) Inventor: Fumihiro Yaguchi, Wako-shi (JP)

(21) Appl. No.: 19/549,179

(22) Filed: Feb. 25, 2026

(30) Foreign Application Priority Data
Mar. 19, 2025 (JP) 2025-044308

(51) Int. Cl. A01D 34/00; A01D 34/43; A01D 101/00

(52) U.S. Cl. CPC A01D 34/006; A01D 34/43; A01D 2101/00

(57) ABSTRACT

A working machine is equipped with vehicle wheels, a working unit, an occupant section in which an occupant of the working machine is capable of riding, a recognition unit disposed more frontward than the occupant section, and an accommodation unit in which the recognition unit is accommodated, wherein a stepped portion that extends in a straight line shape in a front-rear direction of the working machine is disposed on an outer surface of the accommodation unit.

### CROSS-REFERENCE TO RELATED APPLICATIONS

This application is based upon and claims the benefit of priority from Japanese Patent Application No. 2025-044308 filed on Mar. 19, 2025, the contents of which are incorporated herein by reference.

### BACKGROUND OF THE INVENTION

### Field of the Invention

The present invention relates to a working machine.

### Description of the Related Art

In JP 2020-162545 A, there is disclosed a working machine that includes front wheels, rear wheels, a rotating blade disposed between the front wheels and the rear wheels, and a seat on which an occupant sits.

### SUMMARY OF THE INVENTION

There is a long-awaited need for a technology that is capable of improving the straight line stability of such a working machine.

The present invention has the object of solving the aforementioned problem.

An aspect of the present disclosure is characterized by a working machine, comprising vehicle wheels, a working unit, an occupant section in which an occupant of the working machine is capable of riding, a recognition unit disposed more frontward than the occupant section, and an accommodation unit configured to accommodate the recognition unit, wherein a stepped portion configured to extend in a straight line shape in a front-rear direction of the working machine is disposed on an outer surface of the accommodation unit.

According to the present disclosure, the straight line stability of the working machine can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a left side view of a working machine according to one embodiment;

FIG. 2 is a plan view of the working machine;

FIG. 3 is a rear view of the working machine; and

FIG. 4 is a perspective view of an accommodation unit.

### DETAILED DESCRIPTION OF THE INVENTION

In a working machine, it is desirable that a sensor used for external recognition be disposed therein to carry out autonomous travel and autonomous work (autonomous operation) of the working machine. Even in the case that the working machine is capable of carrying out autonomous travel and autonomous work, it is necessary for an operator to operate the working machine during a setting-up stage for the autonomous travel and the autonomous work, at a time of transporting the working machine, and at a time of accommodating the working machine in a garage or the like. At this time, there are cases in which the operator may need to operate the working machine in order to maintain the straight line stability thereof. Specifically, in the case that the working machine is a lawn mower, there are cases in which, in order to ensure the quality of the lawn mowing (the work quality), the operator may need to operate the working machine in order to maintain the straight line stability during the setting up stage of the autonomous travel. Further, there are cases in which the operator drives the working machine in a straight line to load the working machine onto a transport vehicle.

According to the present disclosure, a working machine that is capable of autonomous travel and autonomous work is provided that is capable of improving the straight line stability of the working machine at a time when operated by an operator (an occupant).

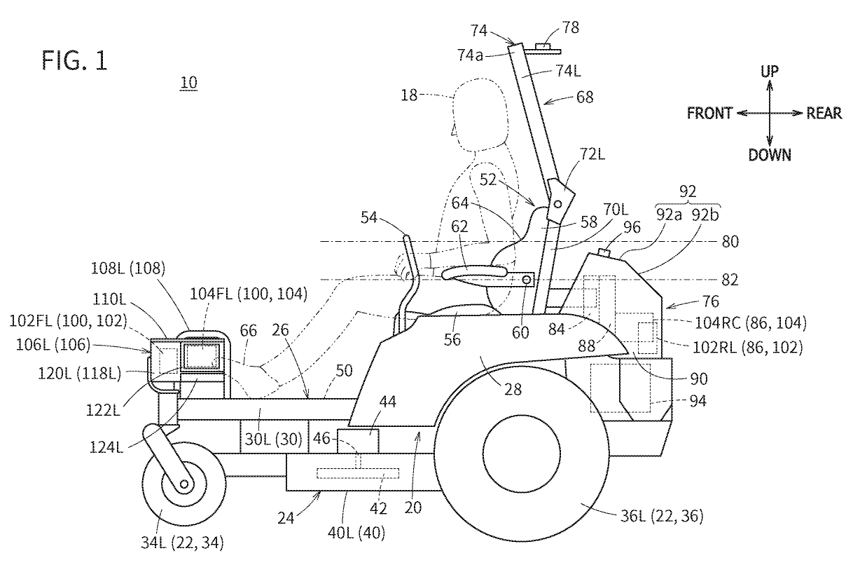

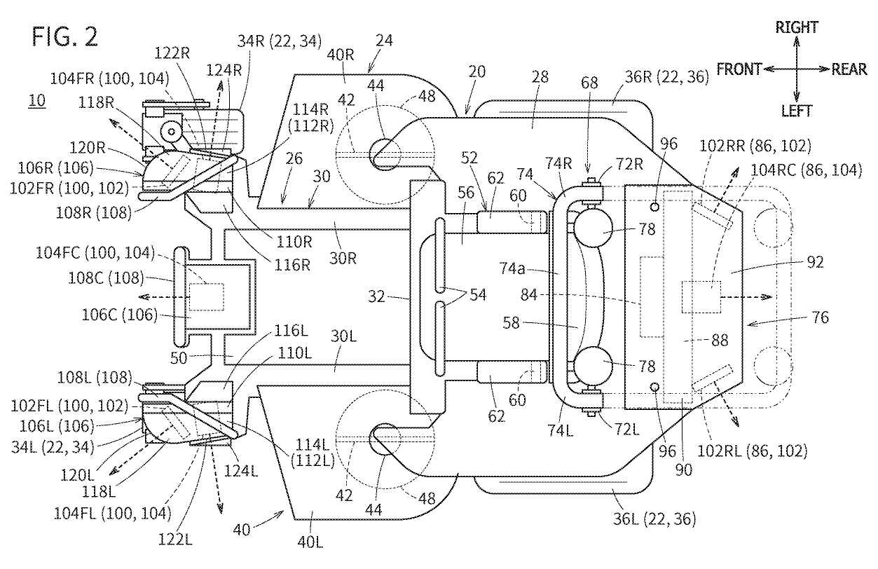

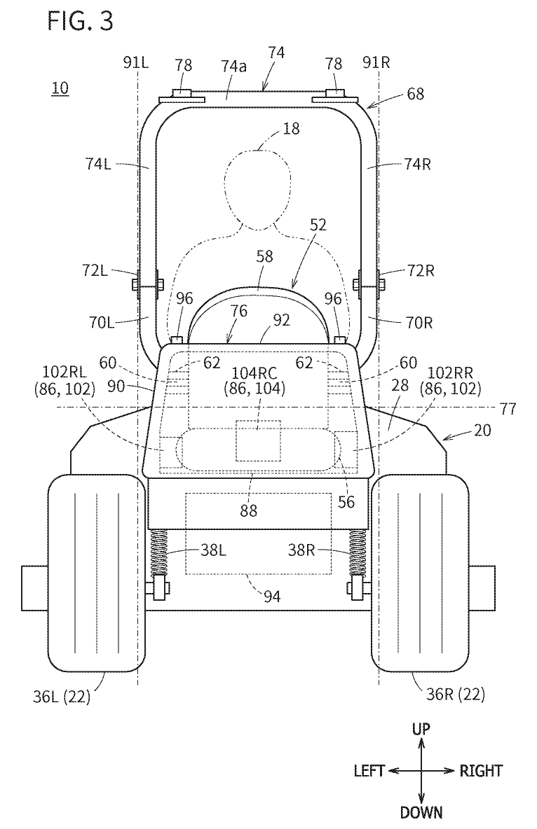

FIG. 1 is a left side view of a working machine 10 according to one embodiment. FIG. 2 is a plan view of the working machine 10. FIG. 3 is a rear view of the working machine 10. In the following description, the direction in which the working machine 10 moves forward is defined as a frontward direction, and the direction in which the working machine 10 moves rearward is defined as a rearward direction, and a front-rear direction, a left-right direction (a vehicle widthwise direction), and an upper/lower direction will be described. The front-rear direction is a direction (a movement direction of the working machine 10) in which the working machine 10 moves forward or moves rearward. The front-rear direction and the left-right direction are horizontal directions of the working machine 10. The upper/lower direction is a direction (a vertical direction) that is perpendicular to the horizontal direction of the working machine 10.

The working machine 10 is a working machine 10 that is capable of at least one of traveling autonomously and working autonomously. The working machine 10 is a working machine 10 on which an occupant 18 (operator) is capable of riding. The working machine 10 is a lawn mower. More specifically, the working machine 10 is a riding lawn mower. The lawn mower is a machine that cuts grass. The working machine 10 is not limited to being a riding lawn mower. The working machine 10 may be a walking type of lawn mower, which is the working machine 10 the occupant 18 pushes from behind. In the following description, a description will be given concerning a case in which the working machine 10 is a riding lawn mower.

As shown in FIGS. 1 and 2, the working machine 10 is equipped with a machine body 20, a plurality of vehicle wheels 22, and a work deck (a working unit) 24. The machine body 20 includes a vehicle body frame 26, and a cover 28.

The vehicle body frame 26 constitutes a framework of the entire working machine 10. The vehicle body frame 26 extends in the front-rear direction. The vehicle body frame 26 comprises a front side frame 30, an intermediate frame 32, and a non-illustrated rear side frame. The front side frame 30 is the front side portion of the vehicle body frame 26. The intermediate frame 32 projects out upwardly from a rear end part of the front side frame 30. The rear side frame extends rearwardly from the intermediate frame 32. The cover 28 covers the intermediate frame 32 and the rear side frame from the left and the right.

The plurality of vehicle wheels 22 include a pair of left and right front wheels 34, and a pair of left and right rear wheels 36.

The front wheels 34 are driven wheels. The front wheels 34 are rotatably connected to the front side frame 30. Specifically, the pair of left and right front wheels 34 are a left front wheel 34L and a right front wheel 34R. The left front wheel 34L and the right front wheel 34R have the same shape and size. The left front wheel 34L is rotatably connected with respect to a left side portion of the front side frame 30. The right front wheel 34R is rotatably connected with respect to a right side portion of the front side frame 30.

The rear wheels 36 are driving wheels. The rear wheels 36 are rotatably connected with respect to the rear side frame. Specifically, the pair of left and right rear wheels 36 are a left rear wheel 36L and a right rear wheel 36R. The left rear wheel 36L and the right rear wheel 36R have the same shape and size. The left rear wheel 36L and the right rear wheel 36R have a larger diameter than the left front wheel 34L and the right front wheel 34R. The left rear wheel 36L is connected to the left side of the rear side frame, via a non-illustrated left swing arm, and a left suspension 38L (refer to FIG. 3). The left rear wheel 36L is rotated by a non-illustrated left traveling motor. The right rear wheel 36R is connected to the right side of the rear side frame, via a non-illustrated right swing arm, and a right suspension 38R (refer to FIG. 3). The right rear wheel 36R is rotated by a non-illustrated right traveling motor.

The work deck 24 is disposed between the pair of left and right front wheels 34 and the pair of left and right rear wheels 36. The work deck 24 is provided on a lower part of the vehicle body frame 26. The work deck 24 includes a housing 40, two blades 42, and two working motors 44.

The housing 40 is mounted on a lower part of the vehicle body frame 26 between the pair of left and right front wheels 34 and the pair of left and right rear wheels 36. The housing 40 is an enclosure that opens downwardly. The housing 40 extends from the front side frame 30 in the vehicle widthwise direction. Specifically, a left side portion of the housing 40 is a left extending portion 40L. The left extending portion 40L extends in a leftward direction from the front side frame 30. A right side portion of the housing 40 is a right extending portion 40R. The right extending portion 40R extends in a rightward direction from the front side frame 30.

The two working motors 44 are mounted respectively on the left extending portion 40L and the right extending portion 40R. Motor shaft portions 46 of the working motors 44 extend downward. The blades 42 are connected to the motor shaft portions 46. Accompanying the working motors 44 being driven, the blades 42 rotate about the axes of the motor shaft portions 46. In FIG. 2, the dashed circles that are coaxial with the working motors 44 are rotation trajectories 48 of end parts of the blades 42.

As shown in FIGS. 1 and 2, a footrest member 50, a seat (an occupant section) 52, and a pair of left and right levers 54 are provided on the vehicle body frame 26. The footrest member 50 is disposed on the front side frame 30. The footrest member 50 is a rectangular plate-shaped portion that is arranged on an inner side of the front side frame 30. The footrest member 50 extends in a horizontal direction.

The seat 52 is disposed on the intermediate frame 32 and the rear side frame. The seat 52 is disposed, rearward of the footrest member 50, on an inner side of the intermediate frame 32 and the rear frame. Accordingly, in the upper/lower direction, the seat 52 is located at a higher position than the footrest member 50.

Specifically, the seat 52 comprises a seat portion 56, a back portion 58, a pair of left and right shaft portions 60, and a pair of left and right armrests 62. The seat portion 56 is disposed, rearward of the footrest member 50, on an inner side of the intermediate frame 32 and the rear frame. The back portion 58 is positioned rearward of the seat portion 56, and is disposed on an inner side of the intermediate frame 32 and the rear frame. The back portion 58 extends upwardly from an inner side of the intermediate frame 32 and the rear frame. An upper end of the back portion 58 is positioned upward of the seat portion 56. The shaft portions 60 are positioned between the upper end of the back portion 58 and the seat portion 56. Specifically, the shaft portions 60 are positioned upward of the seat portion 56. The shaft portions 60 are positioned, from a lower end of the back portion 58, upwardly by a length that is approximately one third of the total length of the back portion 58 in the upper/lower direction. The shaft portions 60 extend outwardly in the vehicle widthwise direction from the back portion 58. The armrests 62 are shaft-supported by the shaft portions 60. The armrests 62 extend frontward from the shaft portions 60.

In the side view of FIG. 1, the back portion 58 has an inflection point 64. The inflection point 64 is formed in a front side portion of the back portion 58. The inflection point 64 is positioned between the upper end of the back portion 58 and the shaft portions 60. More specifically, the inflection point 64 is positioned upward of the shaft portions 60. The inflection point 64 is positioned, from the upper end of the back portion 58, downwardly by a distance that is approximately one third of the total length of the back portion 58 in the upper/lower direction. In the side view of FIG. 1, an upper side portion of the back portion 58 that is more upward than the inflection point 64 is rearwardly recessed. Further, a lower side portion of the back portion 58 that is more downward than the inflection point 64 is formed to be frontward convex.

As shown in FIGS. 1 and 2, the occupant 18 gets in and gets out of the working machine 10 by straddling over the left extending portion 40L or the right extending portion 40R. Specifically, the occupant 18 boards the working machine 10 by straddling over the left extending portion 40L or the right extending portion 40R from a diagonal front of the working machine 10, and placing his or her feet 66 on the footrest member 50. The occupant 18 sits in the seat 52 in a state with his or her feet 66 placed on the footrest member 50. Further, the occupant 18 gets out of the working machine 10 by standing up from the seat 52, straddling over the left extending portion 40L or the right extending portion 40R, and placing his or her feet 66 on the ground surface diagonally in front of the working machine 10.

The pair of left and right levers 54 are disposed diagonally in front of the seat 52. The levers 54 are supported on the intermediate frame 32. The occupant 18, in a state of being seated in the seat 52, is capable of operating the levers 54.

Rearward of the seat 52, an occupant protective mechanism 68 is provided. The occupant protective mechanism 68 is shaft-supported by a left supporting frame 70L and a right supporting frame 70R. The left supporting frame 70L extends upwardly from a left side portion of the rear side frame. The right supporting frame 70R extends upwardly from a right side portion of the rear side frame. As shown in FIGS. 2 and 3, in the vehicle widthwise direction, a distance between the left supporting frame 70L and the right supporting frame 70R is wider than the width of the seat 52. The left supporting frame 70L and the right supporting frame 70R are positioned on outer sides of the seat 52 in the vehicle widthwise direction. As shown in FIGS. 1-3, the occupant protective mechanism 68 includes a left supporting part 72L, a right supporting part 72R, and a safety bar 74.

The left supporting part 72L is supported on an upper end part of the left supporting frame 70L. The right supporting part 72R is supported on an upper end part of the right supporting frame 70R. In the vehicle widthwise direction, a distance between the left supporting part 72L and the right supporting part 72R is wider than the width of the seat 52. The safety bar 74 is a U-shaped frame. The safety bar 74 comprises a bar main body portion 74a, a left connecting portion 74L, and a right connecting portion 74R. A left end part of the bar main body portion 74a is shaft-supported, via the left connecting portion 74L, by the left supporting part 72L. A right end part of the bar main body portion 74a is shaft-supported, via the right connecting portion 74R, by the right supporting part 72R. The safety bar 74 is capable of being rotated about the left supporting part 72L and the right supporting part 72R.

In a state in which the occupant 18 is not riding in the working machine 10, as shown by the two-dot dashed line in FIG. 2, the safety bar 74 is positioned rearward of the seat 52. More specifically, the safety bar 74 is inclined rearward of the seat 52, by being rotated about the left supporting part 72L and the right supporting part 72R. At this time, the bar main body portion 74a is positioned rearwardly of a later-described control device 76. In this state, the occupant 18 (refer to FIG. 1) is capable of getting in and getting out of the working machine 10. Further, in this state, the working machine 10 can be stored, or alternatively, the working machine 10 can be transported.

As shown in FIG. 1, the occupant 18 who is seated in the seat 52 fastens a non-illustrated seat belt that is provided in the working machine 10. In a state in which the occupant 18 is seated in the seat 52, the safety bar 74 is rotated frontward about the left supporting part 72L and the right supporting part 72R (refer to FIGS. 2 and 3), and the bar main body portion 74a is positioned upward of the seat 52. Moreover, even in a state in which the bar main body portion 74a is positioned upward of the seat 52, the occupant 18 is capable of getting in and getting out of the working machine 10.

As shown in FIGS. 1-3, the working machine 10 is further equipped with two GNSS sensors 78. The two GNSS sensors 78 are installed on the safety bar 74. The two GNSS sensors 78 are installed at a predetermined interval on the bar main body portion 74a of the safety bar 74. The two GNSS sensors 78 receive signals emitted from non-illustrated GNSS satellites. The later-described control device 76, based on the signals received by the two GNSS sensors 78, specifies the current position of the working machine 10.

The control device 76 is disposed rearward of the seat 52. The control device 76 is disposed on the rear side frame. As shown in FIG. 3, an upper side portion of the control device 76 is positioned at a height that overlaps with the shaft portions 60 in a rear view. Moreover, the upper side portion of the control device 76 is a portion of the control device 76 that includes a portion more upward than a center line 77 (a center in a heightwise direction) in the upper/lower direction. More specifically, as shown in FIG. 1, the control device 76 is disposed more downward than a first imaginary horizontal plane (an imaginary horizontal plane) 80 that passes through the inflection point 64. Therefore, within the control device 76, an area thereof on a more lower side than a second imaginary horizontal plane 82 that passes through the shaft portions 60 is larger than an area thereof on a more upper side than the second imaginary horizontal plane 82. Stated otherwise, a major portion of the control device 76 is positioned more downward than the second imaginary horizontal plane 82. By the control device 76 being constituted in this manner, the rearward visibility of the occupant 18 who is seated in the seat 52 can be improved.

The control device 76 is positioned upward of the rear wheels 36. In the rear view of FIG. 3, the control device 76 is positioned more inwardly in the vehicle widthwise direction than the safety bar 74. Further, in the rear view of FIG. 3, the control device 76 widens in the vehicle widthwise direction as it proceeds downward. As shown in FIGS. 1-3, the control device 76 comprises a control unit 84, a rearward recognition unit (recognition unit) 86, an inner side frame (frame unit) 88, and a housing (accommodation unit) 90. The housing 90 is disposed, rearward of the seat 52, on the rear side frame. The housing 90 accommodates the control unit 84, the rearward recognition unit 86, and the inner side frame 88. Therefore, the upper end of the housing 90 is also an upper end of the control device 76.

In the side view of FIG. 1, an upper surface 92 of the housing 90 is inclined downward as it proceeds rearward. More specifically, the upper surface 92 of the housing 90 includes a first inclined portion 92a and a second inclined portion 92b. The first inclined portion 92a is a portion of the upper surface 92 of the housing 90, the portion including the upper end of the housing 90. The first inclined portion 92a is inclined diagonally downward as it proceeds rearward. The second inclined portion 92b is a portion of the upper surface 92 of the housing 90, the portion extending rearwardly from the first inclined portion 92a. The second inclined portion 92b is inclined diagonally downward as it proceeds rearward. The second inclined portion 92b has a larger angle of inclination with respect to the front-rear direction than the first inclined portion 92a. By forming the upper surface 92 of the housing 90 in this manner, the rearward visibility of the occupant 18 who is seated in the seat 52 can be effectively improved.

The housing 90, in the rear view of FIG. 3, is positioned more inwardly in the vehicle widthwise direction than an outer edge (an outer end) in the vehicle widthwise direction of the safety bar 74. More specifically, the housing 90 is positioned more on an inner side in the vehicle widthwise direction than straight lines 91L and 91R that extend in the upper/lower direction along the outer ends in the vehicle widthwise direction of the safety bar 74. The housing 90 widens in the vehicle widthwise direction as it proceeds downward. Further, as shown in FIGS. 1 and 2, in the interior of the housing 90, the control unit 84, the inner side frame 88, and the rearward recognition unit 86 are disposed in this order while separating rearwardly away from the back portion 58. Since the control unit 84 is accommodated in the housing 90, the upper end of the control unit 84 is positioned more downward than the upper end of the housing 90. By the upper end of the control unit 84 being lowered, the size of the housing 90 becomes smaller, and the upper end of the housing 90 also becomes lower. In accordance therewith, the rearward visibility of the occupant 18 who is seated in the seat 52 can be effectively improved.

A battery 94 is disposed downward of the housing 90. The control unit 84 can operate when power is supplied from the battery 94. When electrical power is being supplied thereto from the battery 94, the control unit 84 controls each of respective components of the working machine 10 such as the working motors 44 or the like, based on operations of the levers 54 by the occupant 18 who is seated in the seat 52.

The inner side frame 88 is supported by the rear side frame. The inner side frame 88 can support the control unit 84 and the rearward recognition unit 86. The rearward recognition unit 86 recognizes the surrounding vicinity of the working machine 10. The rearward recognition unit 86 is positioned more upward than the plurality of vehicle wheels 22. A detailed description concerning the rearward recognition unit 86 will be given later.

Stop buttons 96 are disposed upward of the control device 76. Specifically, the stop buttons 96 are disposed on the upper surface 92 of the housing 90. Two of the stop buttons 96 are disposed on an upper surface 92 of the housing 90 at an interval from each other in the vehicle widthwise direction. In the rear view of FIG. 3, the stop buttons 96 are disposed outwardly from the seat 52. When the occupant or the like operates the stop buttons 96, the operation of the working machine 10 can be stopped. By arranging the stop buttons 96 in this manner, the operability of the stop buttons 96 is improved.

As shown in FIGS. 1-4, the working machine 10 is further equipped with recognition units that recognize the surrounding vicinity of the working machine 10. In the present embodiment, the recognition unit that is disposed on the front side portion of the working machine 10 is referred to as a frontward recognition unit 100. Further, the recognition unit that is disposed on the rear side portion of the working machine 10 is the aforementioned rearward recognition unit 86.

Each of the frontward recognition unit 100 and the rearward recognition unit 86 includes two types of recognition units with different recognition mechanisms. Each of the frontward recognition unit 100 and the rearward recognition unit 86 includes a first recognition unit 102 and a second recognition unit 104. The first recognition unit 102 recognizes the surrounding vicinity of the working machine 10 by means of a first recognition mechanism. The second recognition unit 104 recognizes the surrounding vicinity of the working machine 10 by means of a second recognition mechanism that is different from the first recognition mechanism.

The first recognition unit 102 is a radar sensor. The first recognition unit 102 is a distance measurement sensor that detects the periphery of the working machine 10. The first recognition unit 102, by emitting radio waves such as millimeter waves or the like around the vicinity of the working machine 10 and receiving reflected waves of the radio waves from a working target object and surrounding objects that are present around the vicinity of the working machine 10 (first recognition mechanism), recognizes the distances and the directions to the working target object and the surrounding objects, as well as the shapes of the working target object and the surrounding objects. The working target object is an object that serves as a target object of the work performed by the working machine 10. Specifically, the working target object is a lawn or grass. Further, the surrounding objects, for example, are obstacles that can become impediments to the work of the working machine 10.

The second recognition unit 104 is a LiDAR sensor. The second recognition unit 104 is a distance measurement sensor that detects the surrounding vicinity of the working machine 10 by means of a recognition mechanism that differs from that of the first recognition unit 102. The second recognition unit 104, by emitting laser light around the vicinity of the working machine 10 and receiving reflected light of the laser light from a working target object and surrounding objects that exist in the surrounding vicinity of the working machine 10 (second recognition mechanism), recognize the distances and the directions to the working target object and the surrounding objects, as well as the shapes of the working target object and the surrounding objects.

Specifically, the frontward recognition unit 100 includes two of the first recognition units 102, and three of the second recognition units 104. The two of the first recognition units 102 and the three of the second recognition units 104 are arranged more frontward than the footrest member 50.

The two of the first recognition units 102 are respectively disposed on the left side and the right side. Among the three of the second recognition units 104, one of the second recognition units 104 is disposed at the center in the vehicle widthwise direction of the working machine 10. The remaining two of the second recognition units 104 are respectively disposed on the left side and the right side.

Three accommodation units 106 are disposed on the front side of the working machine 10. The three accommodation units 106 accommodate therein at least one of the first recognition unit 102 and the second recognition unit 104. The first recognition unit 102 and the second recognition unit 104 are accommodated in the accommodation units 106, and are thereby protected from the exterior of the accommodation units 106.

The three accommodation units 106 are disposed on a front end part of the front side frame 30. As shown in FIG. 1, the three accommodation units 106 are disposed at positions that are higher than the pair of left and right front wheels 34. As shown in FIG. 2, the three accommodation units 106 are disposed more on inner sides in the vehicle widthwise direction than both end parts of the work deck 24 in the vehicle widthwise direction.

Among the three accommodation units 106, a center accommodation unit 106C is disposed in a central portion in the vehicle widthwise direction of the front end part of the front side frame 30. The second recognition unit 104 is accommodated in the center accommodation unit 106C. The second recognition unit 104 which is accommodated in the center accommodation unit 106C is a front center second recognition unit 104FC. A sensor surface of the front center second recognition unit 104FC faces frontward. The front center second recognition unit 104FC recognizes the distances and the directions and the like to the working target object and the surrounding objects that are positioned frontward of the working machine 10.

Among the three accommodation units 106, a left side accommodation unit 106L is disposed in a left corner part of the front end part of the front side frame 30. The left side accommodation unit 106L is positioned upward of the left front wheel 34L. The first recognition unit 102 and the second recognition unit 104 are accommodated in the left side accommodation unit 106L. The first recognition unit 102 which is accommodated in the left side accommodation unit 106L is a front left first recognition unit 102FL. The second recognition unit 104 which is accommodated in the left side accommodation unit 106L is a front left second recognition unit 104FL. In the interior of the left side accommodation unit 106L, the front left first recognition unit 102FL and the front left second recognition unit 104FL are disposed alongside one another in the front-rear direction. The front left first recognition unit 102FL is disposed more frontward than the front left second recognition unit 104FL.

The front left first recognition unit 102FL is accommodated in the left side accommodation unit 106L, in a manner so as to recognize an area diagonally frontward to the left from the working machine 10. More specifically, the front left first recognition unit 102FL is disposed on an inner part of the left side accommodation unit 106L, in a manner so that a sensor surface of the front left first recognition unit 102FL faces diagonally frontward to the left (in a leftward direction and a frontward direction) from the working machine 10. The front left first recognition unit 102FL recognizes the distances and the directions and the like to the working target object and the surrounding objects that are positioned diagonally rearward to the left from the working machine 10.

The front left second recognition unit 104FL is accommodated in the left side accommodation unit 106L, in a manner so as to recognize an area on the left side and diagonally rearward of the working machine 10. More specifically, the front left second recognition unit 104FL is disposed on an inner part of the left side accommodation unit 106L, in a manner so that a sensor surface of the front left second recognition unit 104FL faces (in a leftward direction and a rearward direction) diagonally rearward to the left from the working machine 10. The front left second recognition unit 104FL recognizes the distances and the directions and the like to the working target object and the surrounding objects that are positioned on the left side and diagonally rearward to the left from the working machine 10.

Among the three accommodation units 106, a right side accommodation unit 106R is disposed in a right corner part of the front end part of the front side frame 30. The right side accommodation unit 106R is disposed more on an inner side in the vehicle widthwise direction than the right front wheel 34R. The right side accommodation unit 106R has a shape obtained by inverting the left side accommodation unit 106L from the left to the right. The first recognition unit 102 and the second recognition unit 104 are accommodated in the right side accommodation unit 106R. The first recognition unit 102 which is accommodated in the right side accommodation unit 106R is a front right first recognition unit 102FR. The second recognition unit 104 which is accommodated in the right side accommodation unit 106R is a front right second recognition unit 104FR. In the interior of the right side accommodation unit 106R, the front right first recognition unit 102FR and the front right second recognition unit 104FR are disposed alongside one another in the front-rear direction. The front right first recognition unit 102FR is disposed more frontward than the front right second recognition unit 104FR.

The front right first recognition unit 102FR is accommodated in the right side accommodation unit 106R, in a manner so as to recognize an area diagonally frontward to the right from the working machine 10. More specifically, the front right first recognition unit 102FR is disposed on an inner part of the right side accommodation unit 106R, in a manner so that a sensor surface of the front right first recognition unit 102FR faces diagonally frontward to the right (in a rightward direction and a frontward direction) from the working machine 10. The front right first recognition unit 102FR recognizes the distances and the directions and the like to the working target object and the surrounding objects that are positioned diagonally frontward to the right from the working machine 10.

The front right second recognition unit 104FR is accommodated in the right side accommodation unit 106R, in a manner so as to recognize an area rightward and diagonally rearward to the right from the working machine 10. More specifically, the front right second recognition unit 104FR is disposed on an inner part of the right side accommodation unit 106R, in a manner so that a sensor surface of the front right second recognition unit 104FR faces diagonally rearward to the right (in a rightward direction and a rearward direction) from the working machine 10. The front right second recognition unit 104FR recognizes the distances and the directions and the like to the working target object and the surrounding objects that are positioned rightward and diagonally rearward to the right from the working machine 10.

As noted previously, the rearward recognition unit 86 is accommodated in the housing 90. The rearward recognition unit 86 includes two of the first recognition units 102, and one second recognition unit 104. The two of the first recognition units 102 are a rear left first recognition unit 102RL and a rear right first recognition unit 102RR. The rear left first recognition unit 102RL is disposed on a rear left side of the interior of the housing 90. The rear right first recognition unit 102RR is disposed on a rear right side of the interior of the housing 90. The rear left first recognition unit 102RL and the rear right first recognition unit 102RR are radar sensors. The one second recognition unit 104 is a rear center second recognition unit 104RC. The rear center second recognition unit 104RC is disposed in a rear center of the interior of the housing 90. The rear center second recognition unit 104RC is a LiDAR sensor.

The rear left first recognition unit 102RL, the rear center second recognition unit 104RC, and the rear right first recognition unit 102RR are arranged, in the interior the housing 90, at an interval from each other in the vehicle widthwise direction. The rear left first recognition unit 102RL is disposed, in the interior of the housing 90, in a rear left side corner part. The rear center second recognition unit 104RC is disposed, in the interior of the housing 90, in a rear side center portion. The rear right first recognition unit 102RR is disposed, in the interior of the housing 90, in a rear right side corner part. In the side view of FIG. 1, the rear left first recognition unit 102RL, the rear center second recognition unit 104RC, and the rear right first recognition unit 102RR overlap with each other. In accordance therewith, the overall length of the control device 76 in the upper/lower direction can be made smaller.

The rear center second recognition unit 104RC recognizes the distances and the directions and the like to the working target object and the surrounding objects that are positioned rearward of the working machine 10. More specifically, the rear center second recognition unit 104RC is accommodated in the housing 90, in a manner so that a sensor surface of the rear center second recognition unit 104RC faces rearward.

The rear left first recognition unit 102RL is accommodated in the housing 90, in a manner so as to recognize an area diagonally rearward to the left from the working machine 10. More specifically, the rear left first recognition unit 102RL is disposed in the interior of the housing 90, in the manner so that a sensor surface of the rear left first recognition unit 102RL faces diagonally rearward to the left (in a leftward direction and a rearward direction). The rear left first recognition unit 102RL recognizes the distances and the directions and the like to the working target object and the surrounding objects that are positioned diagonally rearward to the left from the working machine 10.

The rear right first recognition unit 102RR is accommodated in the housing 90, in a manner so as to recognize an area diagonally rearward to the right from the working machine 10. More specifically, the rear right first recognition unit 102RR is disposed in the interior of the housing 90, in the manner so that a sensor surface of the rear right first recognition unit 102RR faces diagonally rearward to the right (in a rightward direction and a rearward direction). The rear right first recognition unit 102RR recognizes the distances and the directions and the like to the working target object and the surrounding objects that are positioned diagonally rearward to the right from the working machine 10.

As shown in FIGS. 1-3, in the working machine 10, a guard member 108 is disposed in proximity to each of the three accommodation units 106. The guard member 108 is a pipe shaped protective member for the purpose of protecting the accommodation units 106 and the frontward recognition unit 100 that is accommodated in the accommodation units 106.

Specifically, the guard member 108 is disposed frontward of the center accommodation unit 106C. The guard member 108 that is disposed frontward of the center accommodation unit 106C is a center guard member 108C. Both ends of the center guard member 108C are fixed to a front end part of the front side frame 30.

The guard member 108 is disposed in proximity to the left side accommodation unit 106L. The guard member 108 that is disposed in proximity to the left side accommodation unit 106L is a left guard member 108L. The left guard member 108L is disposed in a manner so as to straddle over the left side accommodation unit 106L. A front end part of the left guard member 108L is positioned more frontward than the left side accommodation unit 106L. A rear end part of the left guard member 108L is positioned rearward of the left side accommodation unit 106L. Both ends of the left guard member 108L are fixed to left corner parts of a front end part of the front side frame 30.

The guard member 108 is disposed in proximity to the right side accommodation unit 106R. The guard member 108 that is disposed in proximity to the right side accommodation unit 106R is a right guard member 108R. The right guard member 108R is disposed in a manner so as to straddle over the right side accommodation unit 106R. A front end part of the right guard member 108R is positioned more frontward than the right side accommodation unit 106R. A rear end part of the right guard member 108R is positioned more rearward than the right side accommodation unit 106R. Both ends of the right guard member 108R are fixed to right corner parts of the front end part of the front side frame 30.

According to the present embodiment, in order to enhance the straight line stability of the working machine 10 at a time when the occupant 18 who is seated in the seat 52 operates the working machine 10, within the working machine 10, a portion of the constituent elements that are disposed frontward of the seat 52 are formed in a straight line shape along the front-rear direction. Specifically, straight line shaped portions are formed in a portion of the accommodation unit 106, a portion of the front side frame 30, and a portion of the guard member 108. The occupant 18 who is seated in the seat 52 is capable of steering the working machine 10 while being aware of moving straight ahead in the frontward direction by observing the straight line shaped portions. More specifically, the straight line shaped portions function as a guide for the occupant 18 to cause the working machine 10 to travel in a straight line. In accordance therewith, together with improving the straight line stability of the working machine 10, the work quality of the working machine 10 is improved.

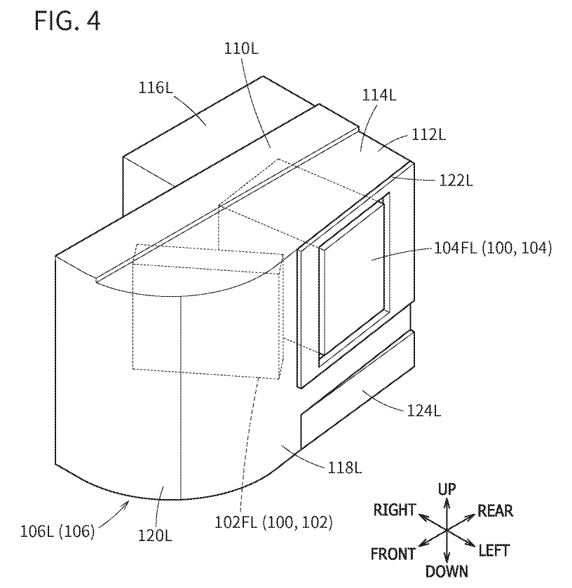

As shown in FIG. 4, on an outer surface 112L of the left side accommodation unit 106L, there is provided a left side stepped portion (stepped portion) 110L that extends in a straight line shape in the front-rear direction. The left side stepped portion 110L is formed on an upper surface 114L of the outer surface 112L of the left side accommodation unit 106L. The left side stepped portion 110L is a rib that projects out upwardly from the upper surface 114L of the left side accommodation unit 106L. In the plan view of FIG. 2, in the left side accommodation unit 106L, the left side stepped portion 110L overlaps with the front left first recognition unit 102FL and the front left second recognition unit 104FL. In accordance therewith, together with the rigidity of the left side accommodation unit 106L being improved by the left side stepped portion 110L, it is possible to suitably protect the front left first recognition unit 102FL and the front left second recognition unit 104FL that are disposed downward of the left side stepped portion 110L.

The left side accommodation unit 106L includes a left side inwardly bulging portion (inwardly bulging portion) 116L that bulges more inwardly in the vehicle widthwise direction than the left side stepped portion 110L. The left side inwardly bulging portion 116L bulges inwardly in the vehicle widthwise direction from a rear side portion of the left side stepped portion 110L. An inner side surface in the vehicle widthwise direction of the left side inwardly bulging portion 116L is formed in a straight line shape in the front-rear direction. Wiring such as harnesses or the like that are connected to the front left first recognition unit 102FL and the front left second recognition unit 104FL can be accommodated in the interior of the left side inwardly bulging portion 116L. The front left first recognition unit 102FL and the front left second recognition unit 104FL are electrically connected, via the wiring, to the control unit 84 (refer to FIGS. 1 and 2).

The left side accommodation unit 106L further includes a left side outwardly bulging portion (outwardly bulging portion) 118L that bulges more outwardly in the vehicle widthwise direction than the left side stepped portion 110L. In the front-rear direction, the overall length of the left side outwardly bulging portion 118L is longer than the overall length of the left side inwardly bulging portion 116L. As noted previously, since the front left first recognition unit 102FL is positioned more frontward than the front left second recognition unit 104FL, a left side curved surface (curved surface) 120L, which follows the sensor surface of the front left first recognition unit 102FL, is formed on a front part of the left side outwardly bulging portion 118L. The left side curved surface 120L is formed on a front side portion of the left side surface of the left side outwardly bulging portion 118L. By forming the left side curved surface 120L, the recognition accuracy of the front left first recognition unit 102FL can be maintained.

The left side accommodation unit 106L further comprises a left side visor member (visor member) 122L and a left side bottom surface part (bottom surface part) 124L. The left side visor member 122L is disposed on a rear part of the left side outwardly bulging portion 118L. The left side visor member 122L is disposed, in a rearwardly directed portion of a left side surface of the left side outwardly bulging portion 118L, in a manner so as to follow the sensor surface of the front left second recognition unit 104FL. Specifically, the left side visor member 122L is disposed to project out in the leftward direction from a rearwardly directed portion of the left side surface of the left side outwardly bulging portion 118L, in a manner so as to surround the sensor surface of the front left second recognition unit 104FL. Therefore, the left side visor member 122L does not interfere with the irradiation of laser light from the front left second recognition unit 104FL. The left side bottom surface part 124L is disposed on a rear part of the left side outwardly bulging portion 118L. The left side bottom surface part 124L bulges outwardly in the vehicle widthwise direction from a location downwardly of the front left second recognition unit 104FL, the location belonging to the rear part of the left side outwardly bulging portion 118L. The left side bottom surface part 124L is formed in a straight line shape in the front-rear direction.

As noted previously, the right side accommodation unit 106R has a shape obtained by inverting the left side accommodation unit 106L from the left to the right. Therefore, a configuration that is similar to that of the left side accommodation unit 106L is also provided in the right side accommodation unit 106R. Specifically, on an outer surface 112R of the right side accommodation unit 106R, there is provided a right side stepped portion (stepped portion) 110R that extends in a straight line shape in the front-rear direction. The right side stepped portion 110R is formed on an upper surface 114R of the outer surface 112R of the right side accommodation unit 106R. The right side stepped portion 110R is a rib that projects out upwardly from the upper surface 114R of the right side accommodation unit 106R. In the plan view of FIG. 2, in the right side accommodation unit 106R, the right side stepped portion 110R overlaps with the front right first recognition unit 102FR and the front right second recognition unit 104FR. In accordance therewith, together with the rigidity of the right side accommodation unit 106R being improved by the right side stepped portion 110R, it is possible to suitably protect the front right first recognition unit 102FR and the front right second recognition unit 104FR that are disposed downward of the right side stepped portion 110R.

The right side accommodation unit 106R includes a right side inwardly bulging portion (inwardly bulging portion) 116R that bulges more inwardly in the vehicle widthwise direction than the right side stepped portion 110R. The right side inwardly bulging portion 116R bulges inwardly in the vehicle widthwise direction from a rear side portion of the right side stepped portion 110R. An inner side surface in the vehicle widthwise direction of the right side inwardly bulging portion 116R is formed in a straight line shape in the front-rear direction. Wiring such as harnesses or the like that are connected to the front right first recognition unit 102FR and the front right second recognition unit 104FR can be accommodated in the interior of the right side inwardly bulging portion 116R. The front right first recognition unit 102FR and the front right second recognition unit 104FR are electrically connected, via the wiring, to the control unit 84 (refer to FIGS. 1 and 2).

The right side accommodation unit 106R further includes a right side outwardly bulging portion (outwardly bulging portion) 118R that bulges more outwardly in the vehicle widthwise direction than the right side stepped portion 110R. In the front-rear direction, the overall length of the right side outwardly bulging portion 118R is longer than the overall length of the right side inwardly bulging portion 116R. A right side curved surface (curved surface) 120R, which follows the sensor surface of the front right first recognition unit 102FR, is formed on a front part of the right side outwardly bulging portion 118R. The right side curved surface 120R is formed on a front side portion of the right side surface of the right side outwardly bulging portion 118R. By forming the right side curved surface 120R, the recognition accuracy of the front right first recognition unit 102FR can be maintained.

The right side accommodation unit 106R further comprises a right side visor member (visor member) 122R and a right side bottom surface part (bottom surface part) 124R. The right side visor member 122R is disposed on a rear part of the right side outwardly bulging portion 118R. The right side visor member 122R is disposed, in a rearwardly directed portion of a left side surface of the right side outwardly bulging portion 118R, in a manner so as to follow the sensor surface of the front right second recognition unit 104FR. Specifically, the right side visor member 122R is disposed to project out in the rightward direction from a rearwardly directed portion of the right side surface of the right side outwardly bulging portion 118R, in a manner so as to surround the sensor surface of the front right second recognition unit 104FR. Therefore, the right side visor member 122R does not interfere with the irradiation of laser light from the front right second recognition unit 104FR. The right side bottom surface part 124R is disposed on a rear part of the right side outwardly bulging portion 118R. The right side bottom surface part 124R bulges outwardly in the vehicle widthwise direction from a location downwardly of the front right second recognition unit 104FR, the location belonging to the rear part of the right side outwardly bulging portion 118R. The right side bottom surface part 124R is formed in a straight line shape in the front-rear direction.

As shown in FIG. 2, a left side partial frame (frame portion) 30L and a right side partial frame (frame portion) 30R, which are part of the front side frame 30, are disposed on both sides of the footrest member 50 in the vehicle widthwise direction. The left side partial frame 30L and the right side partial frame 30R are capable of being viewed from the occupant 18 who is seated in the seat 52 (refer to FIG. 1). The left side partial frame 30L and the right side partial frame 30R extend in a straight line shape in the front-rear direction. The left side partial frame 30L and the left side accommodation unit 106L are disposed in a manner so as to be continuous in the front-rear direction. The right side partial frame 30R and the right side accommodation unit 106R are disposed in a manner so as to be continuous in the front-rear direction.

A front side portion of the left guard member 108L extends further in the frontward direction than the front end of the left side inwardly bulging portion 116L. The front side portion of the left guard member 108L extends in a straight line shape in the front-rear direction. Further, a front side portion of the right guard member 108R extends further in the frontward direction than the front end of the right side inwardly bulging portion 116R. The front side portion of the right guard member 108R extends in a straight line shape in the front-rear direction.

Accordingly, the occupant 18 who is seated in the seat 52, by steering the working machine 10 while observing the straight line shaped portions, is capable of causing the working machine 10 to travel straight ahead. Moreover, the straight line shaped portions of the working machine 10 are not necessarily limited to the above-described configuration. It is sufficient that the straight line shaped portions are formed in a location that lies within the field of vision of the occupant 18 at a time when the occupant 18 who is seated in the seat 52 is looking in the frontward direction.

Next, a description will be given concerning operations of the working machine 10 according to the present embodiment. In this instance, a description will be given of cases in which the working machine 10 undergoes manned and unmanned traveling.

At first, a description will be given concerning a case in which the working machine 10 undergoes manned traveling. The occupant 18 boards the working machine 10 by straddling over the left extending portion 40L or the right extending portion 40R from a diagonal front of the working machine 10, and placing his or her feet 66 on the footrest member 50. The occupant 18 sits in the seat 52 in a state with his or her feet 66 placed on the footrest member 50. The occupant 18 who is seated in the seat 52, by rotating the safety bar 74 frontward about the left supporting part 72L and the right supporting part 72R, positions the bar main body portion 74a more upward than the seat 52. In accordance therewith, the occupant 18 who is seated in the seat 52 becomes capable of being appropriately protected at a time when the working machine 10 tips or rolls over. Further, in the upper/lower direction, the two GNSS sensors 78 can be positioned more upward than the seat 52.

Next, the occupant 18 causes the working machine 10 to be started by operating a non-illustrated ON switch. The control unit 84, based on the operation of the ON switch by the occupant 18, starts the supply of electrical power from the battery 94 to each of the respective components of the working machine 10. In accordance therewith, the two GNSS sensors 78 are driven by the supply of the electrical power from the battery 94, and start to receive signals from the GNSS satellites. The two GNSS sensors 78 output the signals that have been successively received to the control unit 84. Based on the signals received from the two GNSS sensors 78, the control unit 84 specifies the current position of the working machine 10.

Further, each of the frontward recognition unit 100 and the rearward recognition unit 86 is driven by the electrical power supplied from the battery 94, and when objects are present in the surrounding vicinity of the working machine 10, sequentially recognizes the distances and the directions to the working target object and the surrounding objects. The recognition results of each of the frontward recognition unit 100 and the rearward recognition unit 86 are sequentially output to the control unit 84.

The occupant 18, by operating the levers 54, causes the working machine 10 to move forward, move rearward, stop, or turn. More specifically, in accordance with the operation of the levers 54 by the occupant 18, the control unit 84, by controlling the driving of the left traveling motor and the right traveling motor, causes the working machine 10 to move forward, move rearward, stop, or turn. Moreover, it should be noted that pivot turn and spin turn are included within the meaning of the term turn.

At this time, the occupant 18 is capable of operating the levers 54 while observing portions (a part of the accommodation units 106, a part of the front side frame 30, and a part of the guard members 108) of the working machine 10 that extend in a straight line shape in the front-rear direction in front of the seat 52. In accordance therewith, the occupant 18 is capable of steering the working machine 10 while being aware of moving straight ahead in the frontward direction. As a result, the straight line stability of the working machine 10 at a time when moving forward is improved.

The control unit 84 causes the work deck 24 to be raised and lowered in accordance with the operations of the levers 54 by the occupant 18. Further, the control unit 84, in accordance with the operations of the levers 54 by the occupant 18, and by controlling the driving of the two working motors 44 provided on the work deck 24, causes the two blades 42 to undergo rotation or be stopped. Consequently, the working machine 10 is capable of carrying out the grass cutting operation in the working region.

Further, when there is a possibility, based on the respective recognition results of the frontward recognition unit 100 and the rearward recognition unit 86, that the working machine 10 may collide with objects in the surrounding vicinity while the working machine 10 is traveling, the control unit 84 can cause the driving of the left traveling motor and the right traveling motor to be stopped, and thereby cause the traveling of the working machine 10 to be stopped.

When the lawn mowing operation in the working region is completed, the occupant 18 causes the traveling of the working machine 10 to be stopped, and thereafter, operates a non-illustrated OFF switch. In accordance therewith, based on the operation of the OFF switch by the occupant 18, the control unit 84 stops the supply of the electrical power from the battery 94 to each of the respective components of the working machine 10. As a result, the working machine 10 stops operating.

Next, the occupant 18, after having rotated the safety bar 74 rearwardly, stands up from the seat 52, straddles over the left extending portion 40L or the right extending portion 40R from the footrest member 50, and moves onto the ground diagonally in front of the footrest member 50, thereby dismounting from the working machine 10.

Next, a description will be given concerning a case in which the working machine 10 undergoes unmanned traveling. In such unmanned traveling, a teaching process and a playback process are carried out. In the teaching process, the travel route of the working machine 10 in the working region that serves as a target of the lawn mowing operation is stored in the working machine 10 by means of the above-described manned traveling. In the playback process, in an unmanned state in which the occupant 18 is not riding on the working machine 10, the working machine 10 performs the lawn mowing operation while traveling along the travel route that was stored in the teaching process. More specifically, in the playback process, the working machine 10 carries out autonomous travel and autonomous operation.

At first, in the teaching process, in the working region that serves as the target of the lawn mowing operation, the aforementioned manned traveling is carried out in a state in which the operator is riding on the working machine 10. At this time, the control unit 84 stores in a non-illustrated storage device a path (a travel route) that has been traveled by the working machine 10.

Next, in the playback process, the control unit 84, by controlling the driving of the left traveling motor and the right traveling motor in accordance with the travel route that was stored in the storage device, causes the working machine 10 to travel autonomously within the working region. The control unit 84, by controlling the driving of the two working motors 44 and thereby causing the two blades 42 to be rotated, carries out the lawn mowing operation in an autonomous manner.

Even in the playback process, the plurality of recognition units sequentially recognize the distances and the directions and the like to the working target object and the surrounding objects present in the surrounding vicinity of the working machine 10. When there is a possibility, based on the recognition results of the plurality of recognition units, that the working machine 10 may collide with objects in the surrounding vicinity while the working machine 10 is undergoing unmanned traveling, the control unit 84 causes the driving of the left traveling motor and the right traveling motor to be stopped, and thereby causes the traveling of the working machine 10 to be stopped.

The following supplementary notes are further disclosed in relation to the above-described embodiment.

### Supplementary Note 1

The working machine (10) according to the present disclosure comprises the vehicle wheels (22), the working unit (24), the occupant section (52) in which the occupant (18) of the working machine is capable of riding, the recognition unit (100) that is disposed more frontward than the occupant section, and the accommodation unit (106) that serves to accommodate the recognition unit, wherein the stepped portion (110L, 110R) that extends in a straight line shape in the front-rear direction of the working machine is disposed on an outer surface (112L, 112R) of the accommodation unit.

In accordance with such a configuration, the straight line stability of the working machine can be improved. Specifically, since the stepped portion that extends in a straight line shape is formed on the accommodation unit that is disposed frontward of the occupant section, the occupant who rides in the occupant section is capable of operating the working machine while observing the frontward stepped portion. By the operator operating the working machine while being aware of the straight line shaped stepped portion, the straight line stability of the working machine is improved. As a result, the work quality of the working machine can be improved.

### Supplementary Note 2

In the working machine according to Supplementary Note 1, the stepped portion may be disposed on the upper surface (114L, 114R) of the accommodation unit and may overlap the recognition unit as viewed in plan.

In accordance with such a configuration, by providing the stepped portion on the accommodation unit, the rigidity of the accommodation unit is improved. In accordance therewith, it is possible to suitably protect the recognition unit that is disposed downward of the stepped portion.

### Supplementary Note 3

In the working machine according to Supplementary Note 2, the recognition unit may include the first recognition unit (102) that recognizes the surrounding vicinity of the working machine by the first recognition mechanism, and the second recognition unit (104) that recognizes the surrounding vicinity of the working machine using the second recognition mechanism that differs from the first recognition mechanism, and as viewed in plan, the stepped portion may overlap the first recognition unit and the second recognition unit.

In accordance with such a configuration, the first recognition unit and the second recognition unit that are disposed downward of the stepped portion can be suitably protected.

### Supplementary Note 4

In the working machine according to Supplementary Note 2 or 3, the accommodation unit may include the inwardly bulging portion (116L, 116R) that bulges more inwardly in the vehicle widthwise direction of the working machine than the stepped portion, and the inner side surface in the vehicle widthwise direction of the inwardly bulging portion may be formed in a straight line shape in the front-rear direction.

In accordance with such a configuration, it is possible to make the occupant who is riding in the occupant section more effectively recognize that the working machine is moving straight ahead.

### Supplementary Note 5

In the working machine according to Supplementary Note 4, there may further be provided the guard member (108) that extends more frontward than the front end of the inwardly bulging portion, wherein the guard member may extend in a straight line shape in the front-rear direction.

In accordance with such a configuration, while the accommodation unit is protected by the guard member, it is possible to make the occupant who is riding in the occupant section more effectively recognize that the working machine is moving straight ahead.

### Supplementary Note 6

In the working machine according to Supplementary Note 4 or 5, the inwardly bulging portion may accommodate the wiring that is connected to the recognition unit.

In accordance with such a configuration, it is possible to simplify the routing of the wiring.

### Supplementary Note 7

In the working machine according to any one of Supplementary Notes 4 to 6, the accommodation unit may further comprise the outwardly bulging portion (118L, 118R) that bulges more outwardly in the vehicle widthwise direction than the stepped portion.

In accordance with such a configuration, the first recognition unit and the second recognition unit can be appropriately accommodated.

### Supplementary Note 8

In the working machine according to Supplementary Note 7, in the front-rear direction, the overall length of the inwardly bulging portion may be shorter than the overall length of the outwardly bulging portion.

In accordance with such a configuration, the first recognition unit and the second recognition unit can be accommodated in the accommodation unit, and it is possible to make the occupant who is riding in the occupant section more effectively recognize that the working machine is moving straight ahead.

### Supplementary Note 9

In the working machine according to Supplementary Note 7 or 8, the recognition unit may comprise the first recognition unit that recognizes the surrounding vicinity of the working machine by the first recognition mechanism, and the second recognition unit that recognizes the surrounding vicinity of the working machine using the second recognition mechanism that differs from the first recognition mechanism, wherein the first recognition unit may be disposed more frontward than the second recognition unit, and on the front part of the outwardly bulging portion, the curved surface (120L, 120R) may be formed along the sensor surface of the first recognition unit.

In accordance with such a configuration, together with the accommodation unit being formed without waste, the recognition accuracy of the first recognition unit can be maintained.

### Supplementary Note 10

In the working machine according to Supplementary Note 9, the accommodation unit may further include the visor member (122L, 122R) that is disposed on the rear part of the outwardly bulging portion and follows the sensor surface of the second recognition unit, and the bottom surface part (124L, 124R) that is formed in a straight line shape in the front-rear direction downward of the second recognition unit.

In accordance with such a configuration, it is possible to prevent the illumination range of the second recognition unit from being obstructed by the visor member. Furthermore, by forming the bottom surface part, which does not influence the illumination range of the second recognition unit, in a straight line shape, the occupant who is riding in the occupant section can more effectively recognize that the working machine is moving straight ahead.

### Supplementary Note 11

In the working machine according to any one of Supplementary Notes 1 to 10, there may further be provided the frame portion (30L, 30R) that extends forward from the occupant section, wherein the frame portion may be disposed at a position that is capable of being viewed from the occupant section.

In accordance with such a configuration, it is possible to make the occupant who is riding in the occupant section more effectively recognize that the working machine is moving straight ahead.

### Supplementary Note 12

In the working machine according to Supplementary Note 11, there may further be provided the footrest member (50) that is disposed more frontward than the occupant section, and further, on which the occupant who is seated in the occupant section places his or her feet (66), wherein the frame portion may be disposed respectively on both sides of the footrest member in the vehicle widthwise direction of the working machine.

In accordance with such a configuration, it is possible to make the occupant who is riding in the occupant section more effectively recognize that the working machine is moving straight ahead.

### Supplementary Note 13

In the working machine according to Supplementary Note 11 or 12, the frame portion and the accommodation unit may be disposed in a manner so as to be continuous in the front-rear direction.

In accordance with such a configuration, since the straight line shaped portion becomes longer, the occupant who is riding in the occupant section can be made to more effectively recognize that the working machine is moving straight ahead.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

What is claimed is:

1. A working machine, comprising:
vehicle wheels;
a working unit;
an occupant section in which an occupant of the working machine is capable of riding;
a recognition unit disposed more frontward than the occupant section: and
an accommodation unit configured to accommodate the recognition unit;
wherein a stepped portion configured to extend in a straight line shape in a front-rear direction of the working machine is disposed on an outer surface of the accommodation unit.

2. The working machine according to claim 1, wherein the stepped portion is disposed on an upper surface of the accommodation unit and overlaps the recognition unit as viewed in plan.

3. The working machine according to claim 2, wherein:
the recognition unit includes a first recognition unit configured to recognize a surrounding vicinity of the working machine by a first recognition mechanism, and a second recognition unit configured to recognize a surrounding vicinity of the working machine using a second recognition mechanism that differs from the first recognition mechanism; and
the step portion overlaps the first recognition unit and the second recognition unit as viewed in plan.

4. The working machine according to claim 2, wherein:
the accommodation unit includes an inwardly bulging portion configured to bulge more inwardly in the vehicle widthwise direction of the working machine than the stepped portion; and
an inner side surface in the vehicle widthwise direction of the inwardly bulging portion is formed in a straight line shape in the front-rear direction.

5. The working machine according to claim 4, further comprising:
a guard member configured to extend more frontward than a front end of the inwardly bulging portion;
wherein the guard member extends in a straight line shape in the front-rear direction.

6. The working machine according to claim 4, wherein the inwardly bulging portion is configured to accommodate wiring connected to the recognition unit.

7. The working machine according to claim 4, wherein the accommodation unit further comprises an outwardly bulging portion configured to bulge more outwardly in the vehicle widthwise direction than the stepped portion.

8. The working machine according to claim 7, wherein, in the front-rear direction, an overall length of the inwardly bulging portion is shorter than an overall length of the outwardly bulging portion.

9. The working machine according to claim 7, wherein:
the recognition unit comprises a first recognition unit configured to recognize a surrounding vicinity of the working machine by a first recognition mechanism, and a second recognition unit configured to recognize a surrounding vicinity of the working machine using a second recognition mechanism that differs from the first recognition mechanism;
wherein the first recognition unit is disposed more frontward than the second recognition unit; and
on a front part of the outwardly bulging portion, a curved surface is formed along a sensor surface of the first recognition unit.

10. The working machine according to claim 9, wherein the accommodation unit further includes a visor member being disposed on a rear part of the outwardly bulging portion and following a sensor surface of the second recognition unit, and a bottom surface part formed in a straight line shape in the front-rear direction downward of the second recognition unit.

11. The working machine according to claim 1, further comprising
a frame portion extending forward from the occupant section,
wherein the frame portion is disposed at a position that is capable of being viewed from the occupant section.

12. The working machine according to claim 11, further comprising:
a footrest member disposed more frontward than the occupant section, and on which the occupant who is seated in the occupant section places his or her feet;
wherein the frame portion is disposed respectively on both sides of the footrest member in the vehicle widthwise direction of the working machine.

13. The working machine according to claim 11, wherein the frame portion and the accommodation unit are disposed in a manner so as to be continuous in the front-rear direction.
